(19) United States
(12) Patent Application Publication
(10) Pub. No.: US 2017/0002531 A1
(43) Pub. Date: Jan. 5, 2017

(54) PORTABLE ANIMAL REFUSE BAG DISPENSER AND METHOD OF MAKING

(71) Applicant: Wesley Anne Byham, Seattle, WA (US)

(72) Inventor: Wesley Anne Byham, Seattle, WA (US)

(21) Appl. No.: 15/175,883

(22) Filed: Jun. 7, 2016

Related U.S. Application Data
(60) Provisional application No. 62/187,734, filed on Jul. 1, 2015.

(51) Int. Cl. E01H 1/12; D05B 97/10; D05B 13/00; A01K 27/00; B65D 83/08

(52) U.S. Cl. CPC E01H 1/1206; A01K 27/008; B65D 83/0805; D05B 13/00; D05B 97/10; E01H 2001/128

(57) ABSTRACT

A non-plastic, fabric container attachable to a leash with a closure flap and having an opening for dispensing bags and method of making. This design offers consumers a more durable and functional dispenser constructed from a single strip of fabric. A single closure device (button, snap, rivet, turn lock, hook and loop or other simple device) simultaneously encloses the roll of waste bags and attaches the device securely to a leash, harness or belt, etc. With only a single piece of hardware and two side seams, this durable and sanitary design marks a significant departure from previous pet waste bag dispensers. Furthermore, this unique structure creates a virtually universal product that loops around almost anything and accepts almost any brand of waste rolls.

### BACKGROUND

Technical Field

The present disclosure pertains to a device for transporting and dispensing pliable bags and, more particularly, to a non-plastic, fabric container attachable to a pet leash with a closure flap and having an opening for dispensing pet waste bags, and to a method of making the same.

Description of the Related Art

Proper collection and disposal of pet waste is a growing issue with the increasing popularity of urban pets, such as dogs and cats.

For example, in the city of Seattle, Washington, there are more than 125,000 dogs and 60,000 outdoor cats. This amounts to about 50,000 pounds of daily pet waste. When pet waste is left on streets, curb strips and in yards and parks, it becomes a public nuisance and health hazard. In addition, pet waste can be carried by rainwater to storm drains and into creeks, rivers, and lakes without treatment. It is one of the leading causes of bacterial contamination in streams and causes other water quality problems similar to those created by livestock manure and fertilizer.

Pet waste contains bacteria and micro-organisms, including Roundworms, E. coli, and Giardia that can make people and animals sick when ingested or otherwise introduced into the blood. This harmful material can last in yards and lawns for as long as four years if not properly disposed of or otherwise cleaned up. Children who play outside and adults who garden are at greatest risk of infection. When pet waste is washed into storm drains, it eventually ends up in lakes, streams or marine water, where humans can accidentally swallow bacteria and other disease-causing organisms when swimming or playing in the water. These bacteria also end up in shellfish, which then transmit disease to humans upon consumption.

Proper and safe collection, handling, and disposal of pet waste are also regulated by local city and municipality regulations. Pet owners and handlers are required to immediately collect and safely dispose of pet waste when walking pets or when their pets are in off-leash parks.

Most waste bag dispensers today are constructed of rigid plastic materials that use plastic threads and metal or metal-and-plastic clips to hold the bags and attach the dispenser to a leash. This design is fragile, cracking with a single drop on the sidewalk or slam in the door. The design is also annoying to the user because their hard exteriors dangle from the leash and knock against the handler or against the pet when attached to the collar. Attachment hardware can catch in the hair of the pet, irritating the pet as well as frequently creating an annoying sound.

While there are some fabric and knit containers on the market today, they rely on small, complicated seams that easily fail. It is common knowledge that seams and junctions are the most common failure points on almost any product. The majority of products available today are overly-complex and require many connections. Simply put, the more complicated the structure, the more failure points.

Current options are also difficult to clean because they either have intricate construction or tight nooks and crannies. Considering that pet waste bag dispensers are intended for use alongside animal waste it is important that they are easy to clean.

One example of a current pet waste bag dispenser is found in U.S. Pat. No. 7,931,170 issued to Peter H. Che and U.S. Pat. No. 7,410,197 issued to Timothy Edwards. Both of these designs are perfect examples of the issues outlined above. In the case of Che's bag, the complex network of fabric pattern pieces and seams result in a fragile and difficult to clean dispenser. The Edwards's design focuses on the integrated flashlight feature and pays little mind to the structure of the bag dispenser itself. It is easy to see the weak points in the fragile hinges, flanges and moving parts.

### BRIEF SUMMARY

The present disclosure is directed to pet waste bag dispensers that attach to a leash, harness, collar or other secure attachment point on the pet or the handler and dispense waste bags one at a time for use on the go.

In accordance with one aspect of the present disclosure, a device for dispensing pliable bags is provided. The device includes a container having a continuous wall defining an interior cavity, a flap having a first end and a second end, the first end depending from the container, the flap and the container cooperating to form a closed loop, a first connector element on one of the container wall and the flap and a second connector element on the other of the container wall and the flap, the second connector element configured to cooperate with the first connector element to releasably connect the second end of the flap to the container wall, and a dispensing opening formed in the container wall that is sized and shaped to dispense the pliable bags without interference from the flap when the flap is connected to the container wall.

In accordance with another aspect of the present disclosure, the foregoing container and flap are formed from a continuous piece of material that is constructed from bamboo rayon that is woven into fabric material. In one implementation, the first connector element comprises a button attached to the continuous wall, and further wherein the second connector element comprises a button hole formed on the flap and sized and shaped to receive the button to releasably fasten the flap to the container wall.

In accordance with a further aspect of the present disclosure, the first connector and second connector elements are formed of one from among a zipper, hook-and-loop fasteners, a button and hole, male and female snap components, turn locks, clips, clasps, frog closures, hook-and-eye fasteners, rivets, toggle closures, magnets, cord stoppers, buckles, and first and second ties.

In accordance with yet another aspect of the present disclosure, a system is provided that includes a flexible filament, a container having a continuous wall defining an interior cavity, a flap having a first end and a second end, the first end depending from the container, the flap and the container cooperating to form a closed loop for attachment around the flexible filament, a first connector element on one of the container wall and the flap and a second connector element on the other of the container wall and the flap, the second connector element configured to cooperate with the first connector element to releasably connect the second end of the flap to the container wall, and a dispensing opening formed in the container wall that is sized and shaped to dispense the pliable bags without interference from the flap when the flap is connected to the container wall.

In accordance with a further aspect of the foregoing system, the flexible filament can include one from among a collar, a belt, a backpack strap, a fanny pack, a purse, a dog harness, and a leash. Ideally, the system includes a roll of pliable bags sized and shaped to be stored in the interior cavity of the container.

In accordance with still yet another aspect of the present disclosure, a method of making a device for dispensing pliable bags is provided. The method includes, not necessarily in the following order, the steps of (a) forming a rectangular piece of fabric material having first and second longitudinal ends and first and second longitudinal sides extending between the first and second longitudinal ends, (b) providing a first connector element on the piece of fabric material adjacent the second longitudinal end, (c) forming a dispensing opening in the piece of fabric material approximately at a longitudinal midpoint in the piece of fabric material, (d) providing a second connector element on the piece of fabric material that is located at the first longitudinal end of the rectangular material, the second connector element configured to be releasably connected to the first connector element, (e) folding the first longitudinal end of the piece of fabric material over on to the piece of fabric material to form a folded piece of fabric material that overlaps unfolded fabric material and that extends about one-half of the distance towards the second longitudinal end with the first connector element facing outward and away from the unfolded fabric material, and with the first and second longitudinal sides of the folded piece of fabric material overlapping respective first and second longitudinal sides of overlapped unfolded fabric material; and (f) sewing the overlapping first and second longitudinal sides of the overlapping folded piece of material to the respective first and second longitudinal sides of the overlapped unfolded fabric material to form a continuous wall that defines an internal cavity.

In accordance with another aspect of the method, the providing first connector element on the piece of fabric material includes attaching a button on the piece of fabric material that forms the continuous wall, and further wherein providing a second connector element on the piece of fabric material includes forming a button hole in the fabric material that is sized and shaped to receive the button to releasably fasten the second longitudinal end of the piece of fabric material to the continuous wall.

The advantages of the device, system, and method of the present disclosure are numerous. Among them are fewer failure points and greater ease in maintenance and cleaning. This design offers consumers a more durable and functional choice. The dispenser is constructed from a single strip of fabric that consists of two side seams. A single closure device (button, snap, rivet, turn lock, hook and loop or other simple device) simultaneously encloses the roll of waste bags and attaches the device securely to the leash or harness or belt, etc. With only a single piece of hardware and two side seams, this durable and sanitary design marks a significant departure from previous pet waste bag dispensers.

Furthermore, this unique structure creates a virtually universal product. It loops around almost anything and accepts almost any brand of waste rolls.

### BRIEF DESCRIPTION OF THE SEVERAL VIEWS OF THE DRAWINGS

The foregoing and other features and advantages of the present disclosure will be more readily appreciated as the same become better understood from the following detailed description when taken in conjunction with the accompanying drawings, wherein:

FIG. 1 is a side view of a dispenser formed in accordance with the present disclosure and having a roll of waste bags inside the cavity;

FIG. 2 is a rear view of the dispenser of FIG. 1 with the roll of waste bags inside the cavity with individual bags feeding out the rear dispensing hole;

FIG. 3 is a side view in partial cut-away of the dispenser of FIG. 1 with a section removed to reveal the inner roll of waste bags with individual bags feeding out the rear dispensing hole;

FIG. 4 is a top view of the dispenser of FIG. 3 with the closure flap not shown to reveal the roll of waste bags in the internal cavity and individual bags are feeding out the rear dispensing hole;

FIG. 5 shows the front of a dispenser formed in accordance with the present disclosure with a closure flap open and a bag cavity empty; and

FIG. 6 shows the same front view of the dispenser of FIG. 5 with the internal cavity filled with bags;

FIG. 7 is a front view of a dispenser formed in accordance with the present disclosure with the closure flap fastened and a roll of waste bags inside the cavity, and a button closure securing the flap to the container wall;

FIG. 8 is a front view of a dispenser formed in accordance with the present disclosure with the closure flap fastened and a roll of waste bags inside the cavity, and a turn lock fastener securing the flap to the container wall;

FIG. 9 is a front view of a dispenser formed in accordance with the present disclosure with the closure flap fastened and a roll of waste bags inside the cavity, and a snap or rivet fastener securing the flap to the container wall;

FIG. 10 is a front view of a dispenser formed in accordance with the present disclosure with the closure flap fastened and a roll of waste bags inside the cavity, and a hook-and-loop fastener securing the flap to the container wall;

FIG. 11 is a front view of a system formed in accordance with the present disclosure that shows how a dispenser loops around the handle of a leash via the closure flap;

FIG. 12 is a rear view of the system of FIG. 11;

FIG. 13 is a plan view of forming a piece of unfinished material with a button hole and dispensing hole in accordance with the initial steps in a method of making the dispenser in accordance with the present disclosure;

FIGS. 14A-14B are plan views illustrating a hemming and backstitching step in accordance with the method of the present disclosure;

FIGS. 15A-15C are plan views of a front and back side of the piece of material with button holes open and trimmed;

FIGS. 16A-16B are plan views of the front and back sides of the material showing placement and attachment of a button; and

FIG. 17 is a plan view of the formation of the pocket to realize the dispenser in accordance with the method of the present disclosure.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures or components or both associated with leashes, rolls of pet waste bags, and various fasteners such as rivets, snaps, zippers, buttons, and the like have not been shown or described in order to avoid unnecessarily obscuring descriptions of the implementations.

Unless the context requires otherwise, throughout the specification and claims that follow, the word “comprise” and variations thereof, such as “comprises” and “comprising” are to be construed in an open inclusive sense, that is, as “including, but not limited to.” The foregoing applies equally to the words “including” and “having.”

Reference throughout this description to “one implementation” or “an implementation” means that a particular feature, structure, or characteristic described in connection with the implementation is included in at least one implementation. Thus, the appearance of the phrases “in one implementation” or “in an implementation” in various places throughout the specification are not necessarily all referring to the same implementation. Furthermore, the particular features, structures, or characteristics may be combined in any suitable manner in one or more implementations.

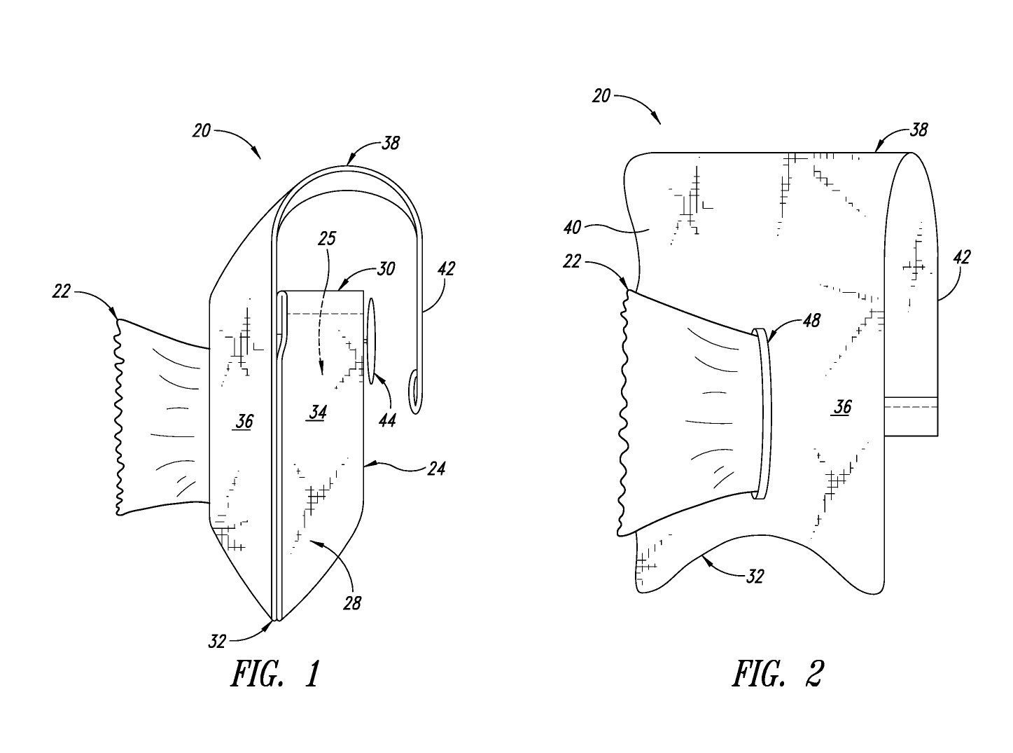

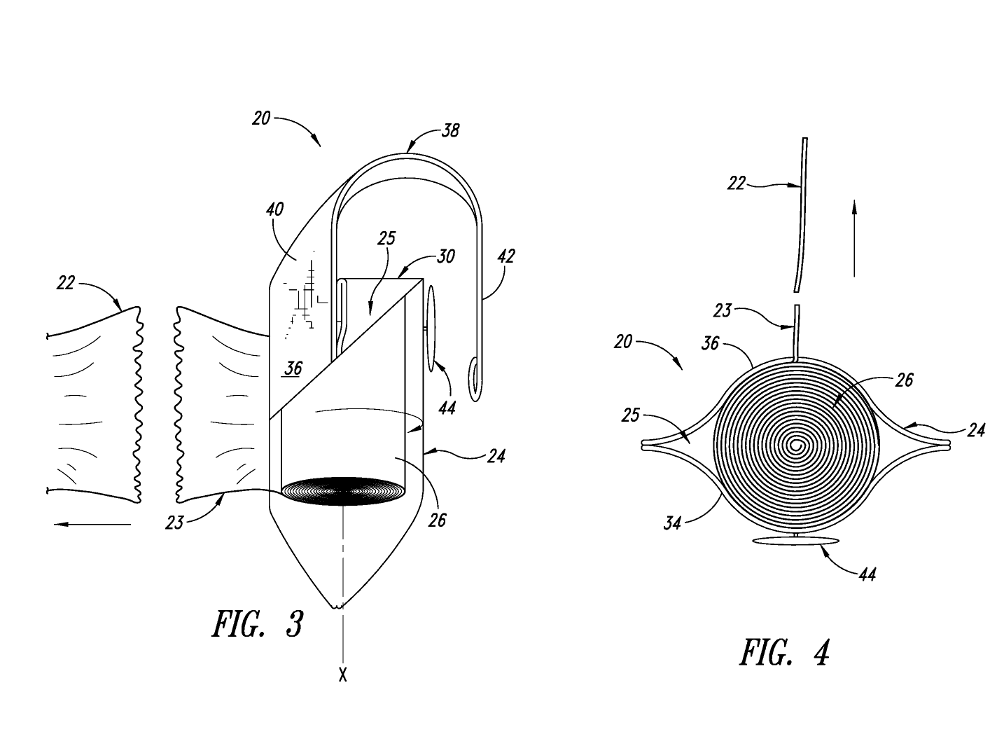

Referring initially to FIGS. 1-6, shown therein are illustrations of a dispenser 20 for pet waste bags 22 in accordance with one implementation of the present disclosure. As shown therein, the dispenser 20 includes a container in the form of a pocket 24 having a longitudinal internal cavity 25 sized and shaped to hold a roll 26 of bags 22 (shown in FIGS. 3 and 4). These rolls 26 of bags 22 are readily commercially available and will not be described in detail herein. Briefly, each bag 22 is connected to adjacent bags 23 by a manually separable perforation such that a pet owner or handler can tear off the bag 22 from an adjacent bag 23 with their hands. The roll 26 is formed around a rotational axis X (shown in FIG. 3) that, when placed in the pocket 24, is in a vertical orientation within the pocket 24, i.e., coincident with a longitudinal axis of the pocket 24.

Ideally the pocket 24 has a side wall 28 that forms an open top 30 and a closed bottom 32 to define the internal cavity 25 as described in more detail below. The open top 30 is sized to receive the roll 26 of bags 22 in the vertical orientation. The sidewall 28 of the pocket 24 has a front section 34 and a rear section 36.

The dispenser 20 also includes a closure flap 38 having a first end 40 attached to or integrally formed with the pocket 24 to depend from the rear section 36 and a second end 42. The flap 38 is sized and shaped to fold over the pocket 24 and cover the open top 30 with the second end 42 securely and removably fastened to the front section 34 of the side wall 28. Ideally a button 44 is attached to the front section 34 of the side wall 28 and a button hole 46 is formed in the second end 42 that is sized and shaped to receive the button 44 and hold the second end 42 of the flap 38 and securely hold the second end 42 of the flap securely to the pocket 24.

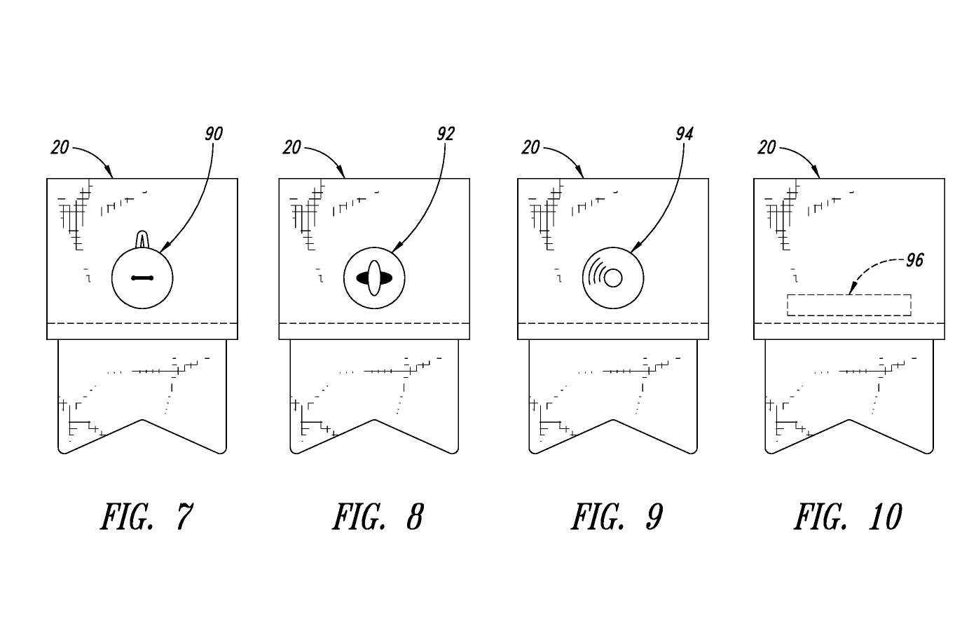

It is to be understood that other known forms of fastening the second end 42 of the flap 38 to the pocket 24 may be used, including without limitation one from among a zipper, hook-and-loop fasteners, a button and hole, male and female snap components, turn locks, clips, clasps, frog closures, hook-and-eye fasteners, rivets, toggle closures, magnets, cord stoppers, buckles, and first and second ties. These are shown in FIGS. 7-10 in which a button closure 90 securing the flap to the container wall is shown in FIG. 7, a turn lock fastener 92 is shown in FIG. 8, a snap or rivet closure 94 is shown in FIG. 9, and a hook-and-loop closure 96 is shown in FIG. 10.

A dispensing hole 48 is formed in the rear section 36 of the side wall 28 that is in communication with the internal cavity 25 of the pocket 24. The dispensing hole 48 is sized and shaped to permit only one individual bag 22 to extend from the roll 26 in the internal cavity 25 to the exterior of the pocket 24. It is also sized and shaped to hold the bag 22 in place so that a portion of the bag extends outside the pocket 24 without unrolling from the roll 26 or extending further from the pocket 24 without being pulled by the pet handler or other user.

In this implementation the dispensing hole 48 is formed in the same manner as the button hole 46, discussed more fully below. The use of a button hole for dispensing bags is non-intuitive because button holes are designed securely receive and hold a button. The inventor has discovered that the button hole not only provides reinforcement at a point where there is frictional engagement with the bag 22, it also provides a small opening that retains its shape due to the hem around the hole 48 and resists unintentional movement of the bag 22. This resistance holds a portion of the bag 22 outside the pocket 24 for easy and quick access by the handler and facilitates holding of the adjacent bag 23 when the bag 22 is torn from the adjacent bag 23.

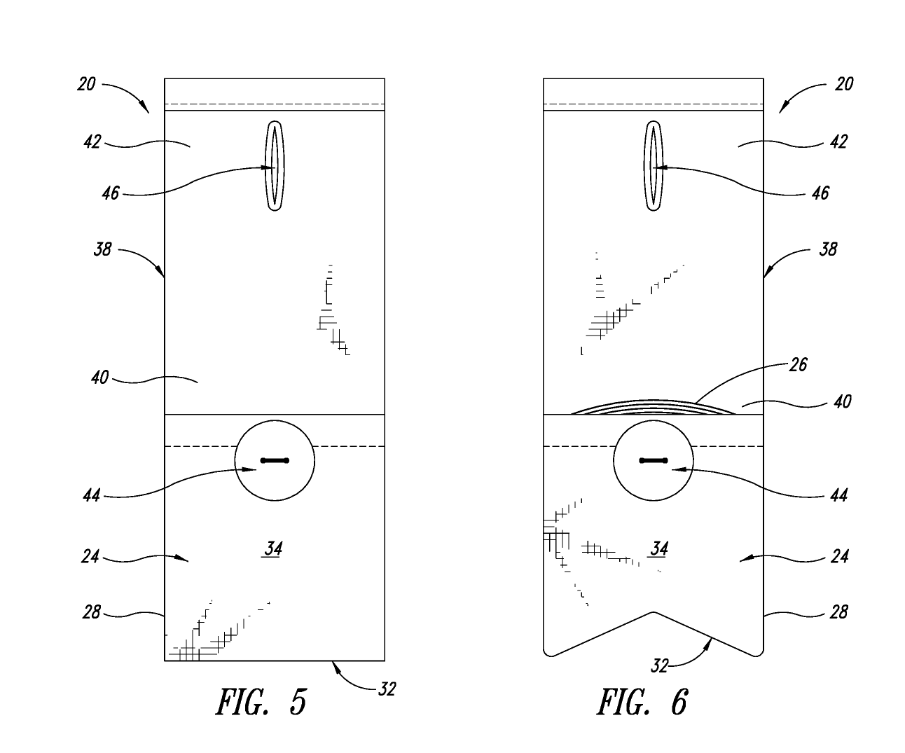

An important feature of this design is the shape of the pocket bottom 32 when the pocket 24 is empty (FIG. 5) and when the pocket 24 is holding the roll 26 of bags 22 (FIG. 6). The pocket bottom 32 has a flat, rectangular shape when the pocket 24 is empty and takes on a puckered configuration when the pocket 24 is holding the roll 26 of bags 22. This puckering is achieved by the type of material and the configuration of the bottom 32 of the pocket 24 as discussed below.

It is to be understood that the dispenser 20 of the present disclosure can be combined with other components to form a system. Generally speaking, the system would include a flexible filament, a container having a continuous wall defining an interior cavity, a flap having a first end and a second end, the first end depending from the container, the flap and the container cooperating to form a closed loop for attachment around the flexible filament, a first connector element on one of the container wall and the flap and a second connector element on the other of the container wall and the flap, the second connector element configured to cooperate with the first connector element to releasably connect the second end of the flap to the container wall, and a dispensing opening formed in the container wall that is sized and shaped to dispense the pliable bags without interference from the flap when the flap is connected to the container wall. Ideally the roll of bags is also included.

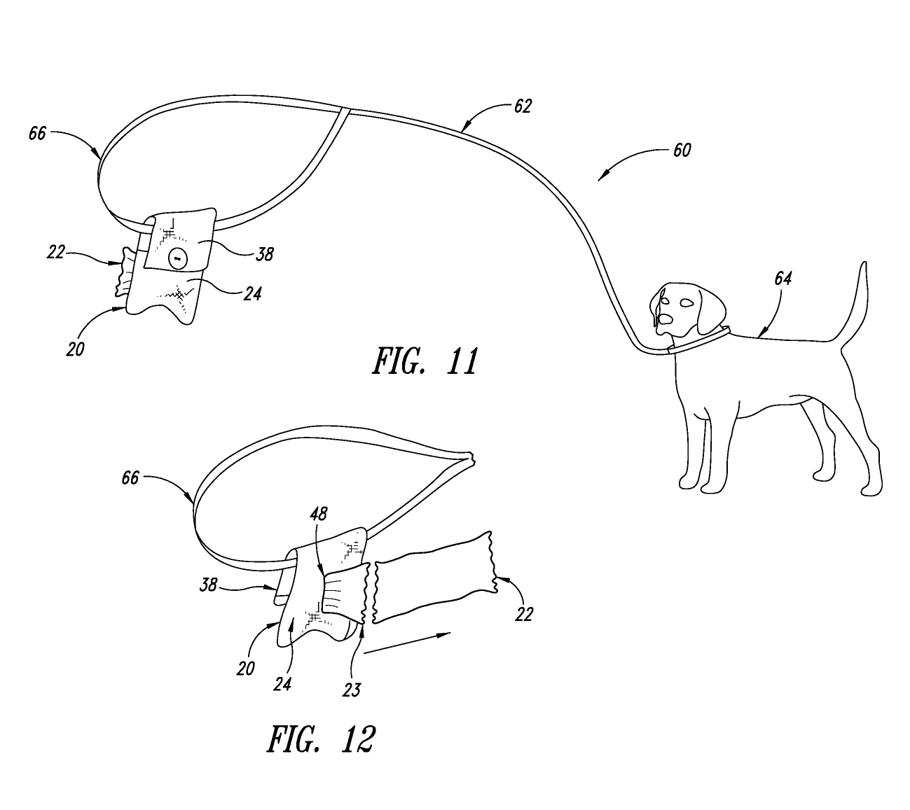

FIGS. 11 and 12 illustrate an implementation of such a system 60 formed in accordance with the present disclosure in which the dispenser 20 described above is used in connection with a leash 62. A pet 64 is shown attached to a free end of the leash 62 but it is to be understood the pet does not form part of the system. The leash 62 includes a handle 66 to which the dispenser 20 is attached. It is to be understood that the leash 62 is one type of flexible filament to which the dispenser 20 can be attached. Other types of flexible filaments include a pet collar, a handler's belt, a belt loop, a bra strap, a backpack strap, a fanny pack, a purse, and a harness such as a pet harness worn by the pet or other harness or similar device worn by the handler.

In use, the handler or user will insert the roll 26 of bags 22 into the pocket. One can easily pinch the first bag 22 from the roll 26 with their fingers and pull it through the dispensing hole 48. Once the bags are threaded through the dispensing hole 48, they will be retained in position by the dispensing hole 48 yet be dispensable with a slight tug. Once loaded with the waste bags, the handler will attach the dispenser 20 to the handle 66 of the leash 62 by looping the closure flap 38 around the handle 66 and securing the closure flap 38 to the pocket 24. Once the roll 26 of bags 22 is exhausted, the user unfastens the flap 38 and inserts a new roll into the pocket 24. The dispenser 20 can be cleaned by washing by hand or in most cases in a washing machine.

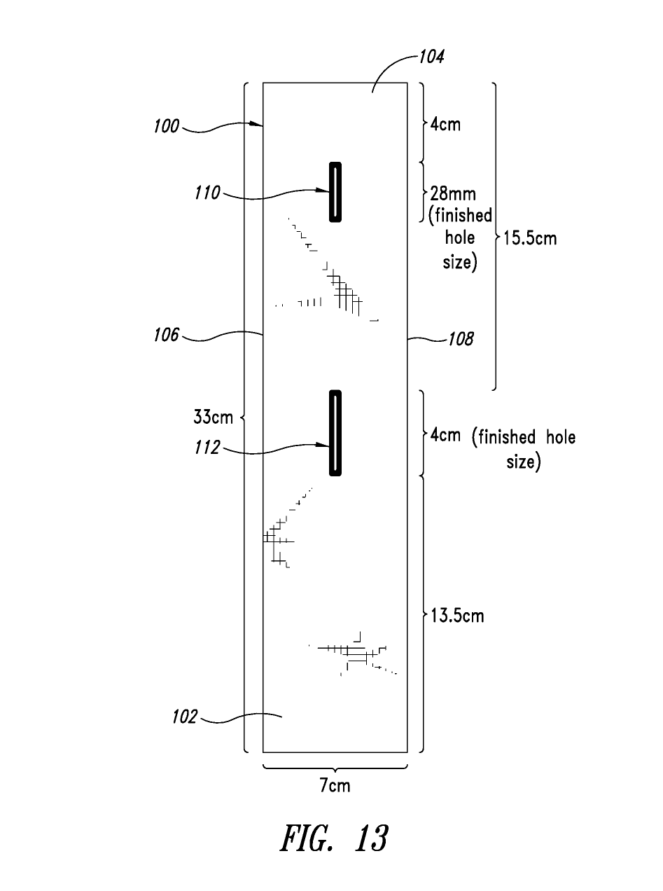

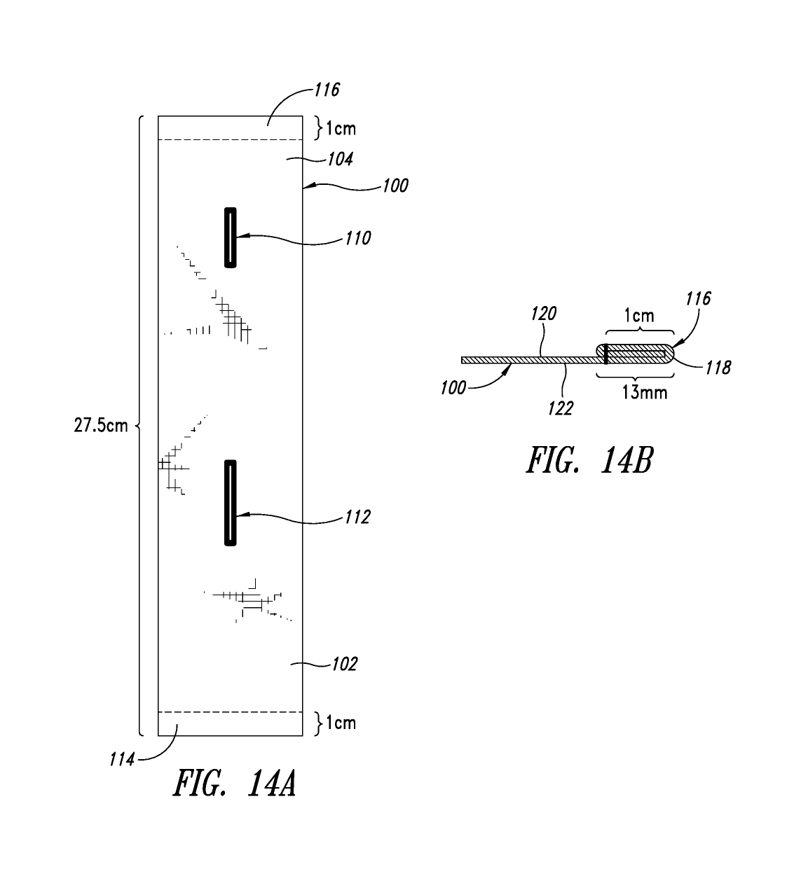

Referring next to FIGS. 13-17, one method of forming the dispenser 20 is illustrated therein and described below. In FIG. 13, a piece of material, in this case a webbing 100 is cut into a rectangular shape. The dimensions shown are preferred sizes for most types of pet waste bags. The piece of material 100 has first and second longitudinal ends 102, 104 and first and second longitudinal sides 106, 108 extending between the first and second longitudinal ends 102, 104.

As shown in FIG. 13, a first connector element, in this implementation a button hole 110 is formed in the piece of material 100 adjacent the second longitudinal end 104. Ideally it has a first end about 4 cm from the terminal end of the second end 104 and is about 28 mm in length and centered laterally and oriented along the longitudinal axis of the piece of material 100 when finished.

Next, a dispensing opening 112 is formed in the piece of material starting about 15.5 cm from the second end 104, located approximately in the middle of the piece of material 100. It extends about 4 cm in length, is centered laterally and oriented along the longitudinal axis of the piece of material 100. As such, the other end of the opening 112 is about 13.5 cm from the first longitudinal end 102.

In FIGS. 14A-14B, the first and second longitudinal ends 102, 104 are then hemmed. Each hem 114, 116 is formed by folding over the end twice to create a 13 mm hem and held in place, preferably with stitching located 1 cm from a terminal end 118. The piece of material 100 has a top surface 120 and a bottom surface 122, and preferably the hem is formed by folding the end on to the top surface 120 as shown in FIG. 14B.

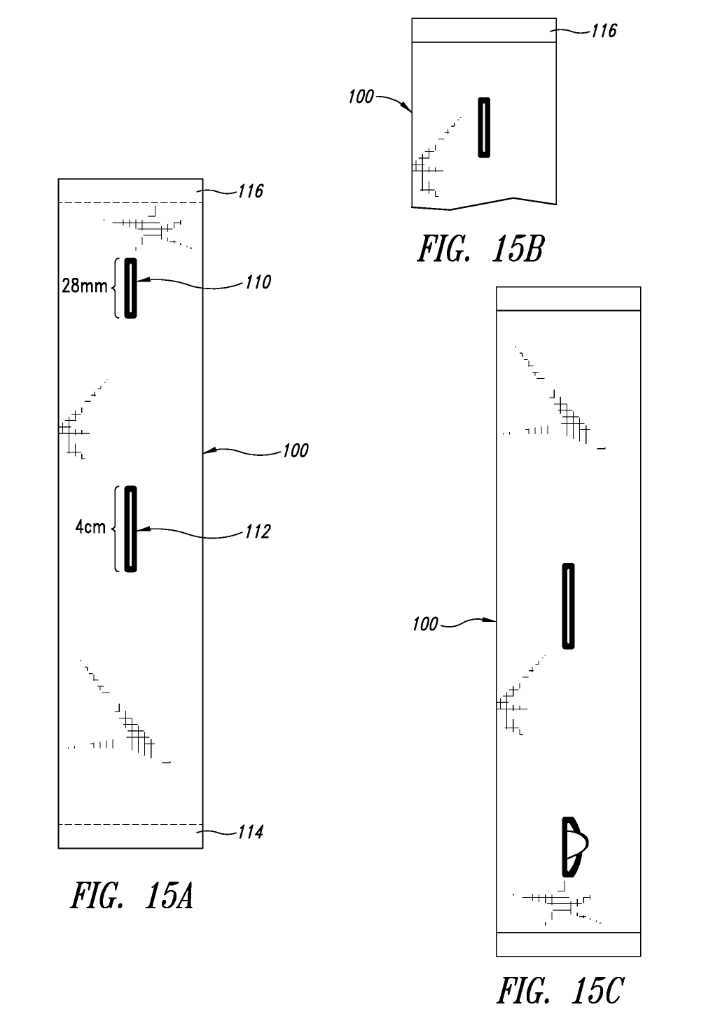

FIGS. 15A-15C show the relative placement of the various features at this stage. FIG. 15B is an enlarged partial view of FIG. 15A showing the location of the button hole 110 to the new hem 116 and its size of 28 mm. Also shown is the size of the dispensing opening 112 at 4 cm. These are preferred sizes to accomplish the intended functionality. FIG. 15C demonstrates that the button holes are open and trimmed. A finger is pictured poking through the hole to demonstrate the opening.

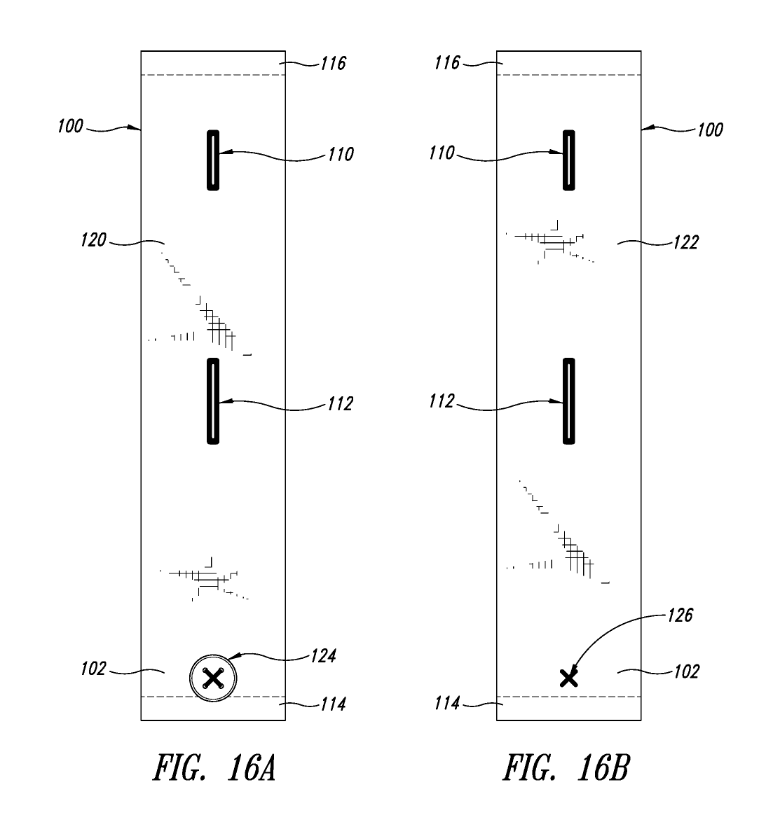

FIGS. 16A-16B show the top and bottom surfaces 120, 122 of the material 100 with the addition of a second connector element, in this implementation a button 124. The button 124 is located at the first longitudinal end 102 adjacent the hem 114 and attached on the top surface 120 by thread 126, seen on the second surface in FIG. 16B. The button 124 is sized and shaped to be received within the button hole 110 so as to be releasably connected or attached thereto. Ideally white polyester thread is used for the thread 126 and the button 124 is as close to the hem 114 as possible.

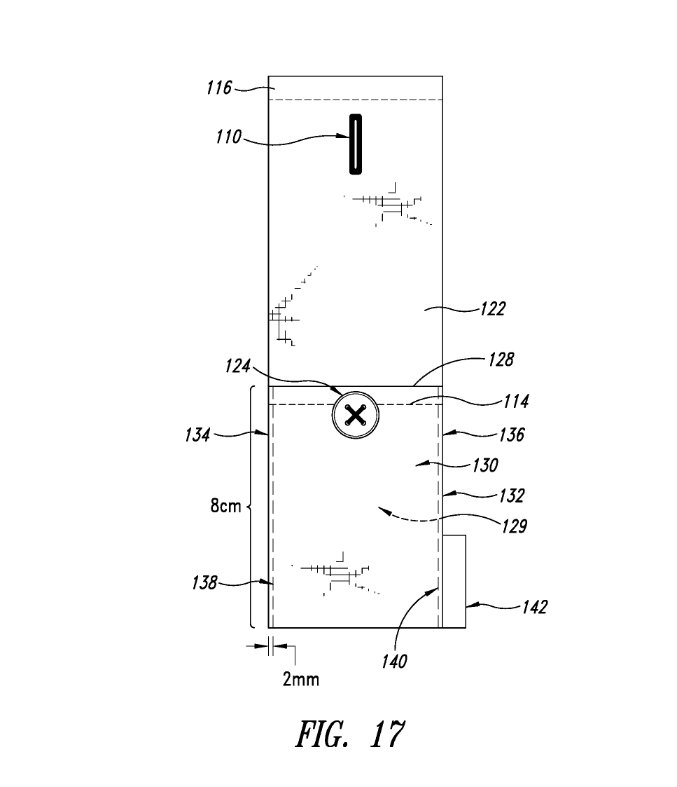

In FIG. 17, the first longitudinal end 102 of the piece of material 100 is folded over on to the bottom surface 122 and extends approximately one-half of the distance towards the second longitudinal end 104. Preferably an 8 cm length of folded material 130 as measured from the terminal end 128 of the hem 114 is folded over to overlap an 8 cm section of unfolded material 129 with the button 124 facing outward and away from the unfolded material to form a pocket 132. The first and second longitudinal edges 134, 136 of the folded piece of material 130 overlap respective first and second longitudinal edges of overlapped unfolded material 132 and are sewn in place with stitching 138, 140 adjacent each longitudinal edge. The sewing of the overlapping first and second longitudinal edges of the overlapping folded material 130 to the respective first and second longitudinal edges of the overlapped unfolded material 129 forms two edge seams that creates a continuous wall, which defines an internal cavity of the pocket 132.

Ideally a polyester thread is used of a color to match the material 100. A tag 142 may be added to one of the edge seams as shown.

The various implementations described above can be combined to provide further implementations. For example, instead of a roll of bags, other types of bags may be used, such as lose grocery bags, sandwich bags, or freezer bags that can be inserted into the pocket 24 and dispensed at will. Aspects of the implementations can be modified, if necessary to employ concepts of the various patents, applications and publications to provide yet further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A device for dispensing pliable bags, comprising:
a container having a continuous wall defining an interior cavity;
a flap having a first end and a second end, the first end depending from the container, the flap and the container cooperating to form a closed loop;
a first connector element on one of the container wall and the flap and a second connector element on the other of the container wall and the flap, the second connector element configured to cooperate with the first connector element to releasably connect the second end of the flap to the container wall; and
a dispensing opening formed in the container wall that is sized and shaped to dispense the pliable bags without interference from the flap when the flap is connected to the container wall.

2. The device of claim 1 wherein the container and flap are formed from a continuous piece of material that is constructed from bamboo rayon that is woven into fabric material.

3. The device of claim 1 wherein the first connector element comprises a button attached to the continuous wall, and further wherein the second connector element comprises a button hole formed on the flap and sized and shaped to receive the button to releasably fasten the flap to the container wall.

4. The device of claim 1 wherein the first connector and second connector elements comprise one from among a zipper, hook-and-loop fasteners, a button and hole, male and female snap components, turn locks, clips, clasps, frog closures, hook-and-eye fasteners, rivets, toggle closures, magnets, cord stoppers, buckles, and first and second ties.

5. A system, comprising:
a flexible filament;
a container having a continuous wall defining an interior cavity;
a flap having a first end and a second end, the first end depending from the container, the flap and the container cooperating to form a closed loop for attachment around the flexible filament;
a first connector element on one of the container wall and the flap and a second connector element on the other of the container wall and the flap, the second connector element configured to cooperate with the first connector element to releasably connect the second end of the flap to the container wall; and
a dispensing opening formed in the container wall that is sized and shaped to dispense the pliable bags without interference from the flap when the flap is connected to the container wall.

6. The system of claim 5 wherein the flexible filament comprises one from among a collar, a belt, a belt loop, a bra strap, a backpack strap, a fanny pack, a purse, a harness, and a leash.

7. The system of claim 6, further comprising a roll of pliable bags sized and shaped to be stored in the interior cavity of the container.

8. The system of claim 5 wherein the first connector and second connector elements comprise one from among a zipper, hook-and-loop fasteners, a button and hole, male and female snap components, turn locks, clips, clasps, frog closures, hook-and-eye fasteners, rivets, toggle closures, magnets, cord stoppers, buckles, and first and second ties.

9. A method of making a device for dispensing pliable bags, the method comprising the steps of:
forming a rectangular piece of fabric material having first and second longitudinal ends and first and second longitudinal sides extending between the first and second longitudinal ends;
providing a first connector element on the piece of fabric material adjacent the second longitudinal end;
forming a dispensing opening in the piece of fabric material approximately at a longitudinal midpoint in the piece of fabric material;
providing a second connector element on the piece of fabric material that is located at the first longitudinal end of the rectangular material, the second connector element configured to be releasably connected to the first connector element;
folding the first longitudinal end of the piece of fabric material over on to the piece of fabric material to form a folded piece of fabric material that overlaps unfolded fabric material and that extends about one-half of the distance towards the second longitudinal end with the second connector element facing outward and away from the unfolded fabric material, and with the first and second longitudinal sides of the folded piece of fabric material overlapping respective first and second longitudinal sides of overlapped unfolded fabric material; and
sewing the overlapping first and second longitudinal sides of the overlapping folded piece of material to the respective first and second longitudinal sides of the overlapped unfolded fabric material to form a continuous wall that defines an internal cavity.

10. The method of claim 9 wherein the providing first connector element on the piece of fabric material comprises attaching a button on the piece of fabric material that forms the continuous wall, and further wherein providing a second connector element on the piece of fabric material comprises forming a button hole in the fabric material that is sized and shaped to receive the button to releasably fasten the second longitudinal end of the piece of fabric material to the continuous wall.
